(19) United States
(12) Patent Application Publication
(10) Pub. No.: US 2025/0272408 A1
(43) Pub. Date: Aug. 28, 2025

(54) METHODS, SYSTEMS, AND APPARATUS FOR ENHANCING DATA SECURITY FOR COMPUTING DEVICES OVER A NETWORK

(71) Applicant: Evernorth Strategic Development, Inc., St. Louis, MO (US)

(72) Inventors: David B. Pickens, Cottage Grove, MN (US); David R. Gonzalez, Cary, NC (US); Matthew P. Kettledon, West Hartford, CT (US)

(21) Appl. No.: 18/212,225

(22) Filed: Jun. 21, 2023

(51) Int. Cl. G06F 21/57; G06Q 10/0631

(52) U.S. Cl. CPC G06F 21/577; G06Q 10/06311; G06F 2221/034

(57) ABSTRACT

A method for enhancing data security for computing devices over a network is provided. The method performs an automated data security process for at least one external computing device, according to a schedule, including: performing a scan of the at least one external computing device using one or more third-party software applications; obtaining classification data for potential security vulnerabilities applicable to the at least one external computing device; identifying an actual security vulnerability, based on the scan and the classification data; accessing a first database storing organizational data associated with the potential security vulnerabilities; determining current ownership for the actual security vulnerability, based on the organizational data; and determining a priority level for the actual security vulnerability. The method also presents a dashboard including graphical elements and text associated with the actual security vulnerability, and transmits a notification or ticket to the current ownership, based on the priority level.

### TECHNICAL FIELD

Embodiments of the subject matter described herein relate generally to data security practices. More particularly, embodiments of the subject matter relate to improving data security for network-connected computing devices.

### BACKGROUND

Most organizations rely on computer-based systems to perform substantive, core functions, to maintain and update records, or to perform other operations as required. Such computer-based systems are typically networked for convenience and rapid communications. Data security can be a primary concern for a networked computing environment, due to the connected nature of the computing devices on the network. In an enterprise environment, maintaining data security for large quantities of computing devices may become cumbersome, as each computing device is operated by a different person and different parties may be responsible for performing data security tasking for different computing devices or groups of computing devices. Structuring, prioritizing, and ensuring performance of data security tasking can easily become difficult to manage as the organization grows.

### BRIEF SUMMARY

A method is provided for enhancing data security for computing devices over a network. The method establishes communication connections to at least one external computing device over the network, by at least one processor communicatively coupled to a memory device, wherein the computing devices include the at least one external computing device; and performs an automated data security process according to a schedule.

The method performs the automated data security process according to a schedule, and the automated data security process includes: (i) performing a scan of the at least one external computing device using one or more software applications, by the at least one processor via the network; (ii) obtaining classification data for potential security vulnerabilities applicable to the at least one external computing device; (iii) identifying an actual security vulnerability for the at least one external computing device, based on the scan and the classification data, by the at least one processor, wherein the potential security vulnerabilities include the actual security vulnerability; (iv) accessing a first database storing organizational data associated with the potential security vulnerabilities, by the at least one processor via the network; (v) determining current ownership for the actual security vulnerability, by the at least one processor, based on the organizational data; and (vi) determining a priority level for the actual security vulnerability, by the at least one processor. The one or more software applications can be third party applications. In an example embodiment, the one or more software applications can include internal applications, third party applications, or combinations thereof.

The method also presents a dashboard including graphical elements and text associated with the actual security vulnerability and at least one of: the classification data. the current ownership, and the priority level, via a display device communicatively coupled to the at least one processor. Additionally, the method transmits a notification or ticket to the current ownership of the actual security vulnerability, based on the priority level, by the at least one processor via the communication connections. The notification can include graphical elements produced by the processor on a display.

A system is provided for enhancing data security for computing devices over a network. The system includes a memory component; a communication device configured to establish communication connections to at least one external computing device over the network, wherein the computing devices include the at least one external computing device; and at least one processor communicatively coupled to the memory component and the communication device.

The at least one processor is configured to perform an automated data security process according to a schedule, wherein the automated data security process comprises: (i) performing a scan of the at least one external computing device using one or more software applications (e.g., third-party applications), via the communication device using the communication connections; (ii) obtaining classification data for potential security vulnerabilities applicable to the at least one external computing device; (iii) identifying an actual security vulnerability for the at least one external computing device, based on the scan and the classification data, wherein the potential security vulnerabilities include the actual security vulnerability; (iv) accessing a first database storing organizational data associated with the potential security vulnerabilities, via the communication device using the communication connections; (v) determining current ownership for the actual security vulnerability, based on the organizational data; and (vi) determining a priority level for the actual security vulnerability.

The at least one processor is also configured to present a dashboard including graphical elements and text associated with the actual security vulnerability and at least one of: the classification data, the current ownership, and the priority level, via a display device communicatively coupled to the at least one processor. Additionally, the at least one processor is configured to transmit a notification or ticket to the current ownership of the actual security vulnerability, based on the priority level, via the communication device using the communication connections. Each of the security vulnerability, classification, ownership, and priority can change the graphical elements on the dashboard.

A non-transitory, computer-readable medium is provided. The non-transitory, computer-readable medium contains instructions thereon, which, when executed by a processor, perform a method. The method establishes communication connections to at least one external computing device over the network, by the processor communicatively coupled to a memory device, wherein the computing devices include the at least one external computing device; and performs an automated data security process according to a schedule.

The automated data security process includes: (i) performing a scan of the at least one external computing device using one or more software applications (e.g., third-party applications), by the processor via the network; (ii) identifying an actual security vulnerability for the at least one external computing device, based on the scan, by the processor; (iii) determining current ownership for the actual security vulnerability, by the processor, based on organizational data associated with potential security vulnerabilities for the at least one external computing device; and (iv) determining a priority level for the actual security vulnerability, by the processor.

The method also presents a dashboard including graphical elements and text associated with the actual security vulnerability and at least one of: the classification data, the current ownership, and the priority level, via a display device communicatively coupled to the processor. Additionally, the method transmits a notification or ticket to the current ownership of the actual security vulnerability, based on the priority level, by the processor via the communication connections.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIGS. 1A-1B are diagrams of a system for enhancing data security for computing devices over a network, in accordance with the disclosed embodiments;

FIG. 2 is a functional block diagram of a server system for use in a system for enhancing data security for computing devices over a network, in accordance with the disclosed embodiments;

FIG. 3 is a diagram illustrating interactivity between an Application Programming Interface (API) and a plurality of third-party software applications, in accordance with the disclosed embodiments;

FIG. 4 is a flow chart that illustrates an embodiment of a process for enhancing data security for computing devices over a network;

FIG. 5 is a flow chart that illustrates an embodiment of a process for performing an automated data security process according to a schedule that includes at least one of a timed interval schedule and an event-triggered schedule;

FIG. 6 is a flow chart that illustrates an embodiment of a process for identifying an actual security vulnerability, based on a scan and classification data;

FIG. 7 is a flow chart that illustrates an embodiment of a process for determining current ownership of an actual security vulnerability;

FIG. 8 is a flow chart that illustrates an embodiment of a process for determining a priority level for an actual security vulnerability; and

FIG. 9 is a flow chart that illustrates an embodiment of a process for providing compliance data for an actual security vulnerability.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

The present disclosure describes structures and procedures to enhance data security for computing devices over a network. It may be desirable to take additional or differing steps to enhance data security when such computing devices are part of an enterprise system. An enterprise system can include the technology for scaled businesses that may utilize multiple technology resources, i.e., different hardware and software executing on the hardware. The use of dispersed hardware and software networked together may require improved security. Furthermore, other desirable features and characteristics will become apparent from the subsequent detailed description and the appended claims, taken in conjunction with the accompanying drawings and the foregoing technical field and background.

The subject matter presented herein relates to systems, apparatus, and methods for enhancing data security for a plurality of computing devices operating as part of a networked computing environment. More specifically, a centralized server system or other computer system on the network identifies and prioritizes currently existing security vulnerabilities for the computing devices, based on factors that include priority level, ownership, age, and the like. The centralized server system also identifies current owners or parties responsible for taking corrective action with regard to an identified security vulnerability, and transmits notifications (e.g., tickets) to current owners regarding current security vulnerabilities.

Security vulnerability data is typically obtained by the centralized server system is used as a “primary” platform to interact with a plurality of “secondary” data security platforms (i.e., third-party software applications) to obtain security vulnerability data for the computing devices. Thus, the centralized server system provides a single-platform interaction and evaluation of security vulnerability data that may otherwise require developers or other data security personnel to interact with a plurality of different platforms to obtain.

Additionally, the centralized server system generates and maintains compliance data regarding various statuses of the plurality of computing devices. The statuses may include one or more of the following: security vulnerabilities, recommended actions, completed actions, partially complete and/or incomplete actions, ownership, priority level, dates and/or times at which security vulnerability actions were taken and/or a security vulnerability status is changed, and any other applicable security vulnerability data parameter, as needed for the particular implementation, including combinations thereof.

The centralized server system also performs security vulnerability data analysis and generates real-time reports (e.g., electronic records) based on current and past security vulnerability data. Based on such reports, the centralized server system may also provide a graphical and/or text-based representation of current and past security vulnerability conditions for computing devices over the network (the graphical representation can be provided on a display with or without corresponding text in the electronic record). Security vulnerability reporting is based on aggregated data obtained from a plurality of secondary sources (e.g., third-party software applications), and may be presented as part of a snapshot, dashboard, or other type of aggregated summary presentation from a combined set of sources. In this way, the centralized server system again functions as the primary platform for interactivity with the developers or other data security personnel, to provide a consolidated view (i.e., “a single pane of glass”) of security vulnerability data, trends, ownership, priority level, corrective actions and associated stages of completion, and the like. The graphical and/or text-based representation of the current and past security vulnerability conditions includes the consolidated view (i.e., summary, snapshot, dashboard, “single pane of glass”, or other aggregated summary presentation). The consolidated view can be generated from electronic records.

Certain terminologies are used with regard to the various embodiments of the present disclosure for ease of illustration and explanation.

A security vulnerability, in at least some examples described herein of a computing and/or networking environment, is an error, misconfiguration, flaw, or other weakness that may enable the occurrence of adverse events. Adverse events may be unintentionally caused, or may be the result of intentionally exploiting a security vulnerability.

A primary platform, in at least some examples described herein, is a centralized computer system (e.g., a centralized server system) that performs security vulnerability analysis, reporting, and ticketing functions for a plurality of computing devices over a network. The primary platform interacts with one or more secondary platforms to obtain and aggregate security vulnerability data used in analysis and reporting. An example of a primary platform may be a centralized computer system or server system that centrally organizes and controls data security operations over the network.

A secondary platform, in at least some examples described herein, is one of a set of security vulnerability data sources, which may include, but are not limited to: executable programs or applications, data storage entities, or the like. An example of a secondary platform may be a third-party software application and/or a database.

An enterprise computing environment, as described herein, is a networked computing environment that includes a centralized computer system operating as a primary platform for interactions with a plurality of secondary platforms directly applicable to obtaining security vulnerability data from a plurality of computing devices on the network. The enterprise computing environment includes the central server system and the plurality of networked computing devices. In certain embodiments of the present disclosure, the enterprise computing environment may also include the secondary platforms (e.g., third-party software applications).

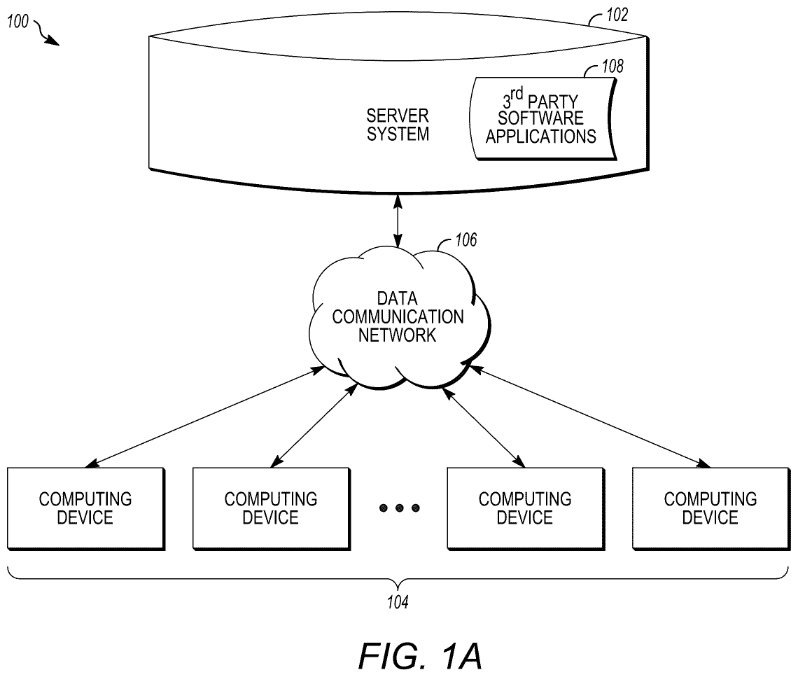

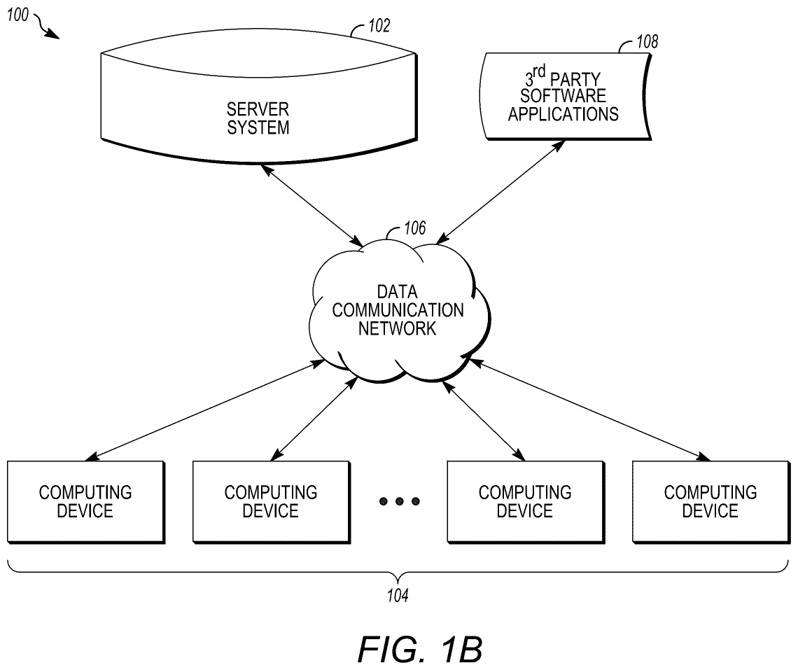

Turning now to the figures, FIGS. 1A-1B are diagrams of a system 100 for enhancing data security for computing devices 104 over a network 106, in accordance with the disclosed embodiments. Typical embodiments of the system 100 are implemented in a computing environment wherein a plurality of third-party software applications 108 are used to interact with, and obtain data from, at least one external computing device 104. FIG. 1A is a diagram of the system 100 for enhancing data security, wherein the system 100 includes third-party software applications 108 that are internally stored and maintained by a server system 102. FIG. 1B is also a diagram of the system 100 for enhancing data security, wherein the system 100 includes third-party software applications 108 that are stored in a location external to the server system 102. It should be noted that both of the embodiments shown in FIGS. 1A and 1B are operable to perform the same (or substantially similar) data security analysis and operations, as described herein.

As shown in FIG. 1A, the server system 102 is a centralized computer system, which may be used by developers, analysts, team leaders, and/or any party responsible for performing data security and/or security vulnerability analysis or response operations. As described herein, the server system 102 operates as a central computer system that monitors a current status of computing devices 104, with regard to security vulnerabilities. The server system 102 is also operable to perform security vulnerability analysis, reporting, and ticketing functions, based on the information obtained via the monitoring. The server system 102 may be implemented as any number of application servers, and each server may be implemented using any suitable computer. In some embodiments, the server system 102 includes one or more dedicated computers. In some embodiments, the server system 102 includes one or more computers performing other operations, in addition to server-specific functionality.

The server system 102 is operable to exchange data communications with (i) a plurality of computing devices 104, and (ii) one or more third-party software applications 108, via the data communication network 106. The data communication network 106 may be any digital or other communications network capable of transmitting messages or data between devices, systems, or components. In certain embodiments, the data communication network 106 includes a packet switched network that facilitates packet-based data communication, addressing, and data routing. The packet switched network could be, for example, a wide area network, the Internet, or the like. In various embodiments, the data communication network 106 includes any number of public or private data connections, links, or network connections supporting any number of communications protocols. The data communication network 106 may include the Internet, for example, or any other network based upon TCP/IP or other conventional protocols. In various embodiments, the data communication network 106 could also incorporate a wireless and/or wired telephone network, such as a cellular communications network for communicating with mobile phones, personal digital assistants, or the like. The data communication network 106 may also incorporate any sort of wireless or wired local and/or personal area networks, such as one or more IEEE 802.3, IEEE 802.16, and/or IEEE 802.11 networks, and/or networks that implement a short range (e.g., BLUETOOTH) protocol. For the sake of brevity, conventional techniques related to data transmission, signaling, clocking, network control, and other functional aspects of the systems (and the individual operating components of the systems) may not be described in detail herein, but may be used with the presently described system.

The computing devices 104 may include any suitable computer that is external to the central server system 102 and communicatively coupled to the server system 102 via the data communication network 106. The computing devices 104 may be implemented as part of an enterprise environment, wherein data security analysis and security vulnerability responses for a group of computing devices are centrally managed. However, it should be appreciated that the computing devices 104 may be implemented as part of any suitable environment wherein a central server system 102 functions to monitor, identify, report, and/or ticket security vulnerabilities for a plurality of computing devices 104. The computing devices 104 are capable of communicating with the centralized server system 102 via the data communication network 106.

As described herein, the server system 102 is operable to exchange data communications with (i) a plurality of computing devices 104, and (ii) one or more third-party software applications 108, via the data communication network 106. Data communications transmitted by the server system 102 to the plurality of computing devices 104 may include, but are not limited to: notifications and/or “tickets” regarding current and/or past security vulnerabilities.

For purposes of the present disclosure, a notification is an initial message to an “owner”, or in other words, a person or group of people responsible for taking action in response to security vulnerabilities associated with a particular one of the computing devices 104. A notification reports that a particular security vulnerability has been identified and is active on one of the computing devices 104, and includes an informal request to take corrective action according to established policy. A ticket is a formalized notification transmitted to the owner according to a timed interval schedule, when corrective action has not been taken within a predetermined timeframe and according to established policy. Some embodiments of a ticket may require a response from the owner, wherein the response includes at least one of (i) a proposed timeframe for taking corrective action, and (ii) a description of the corrective actions that will be completed within the proposed timeframe. In an example scenario, Owner A may receive a notification reporting that Vulnerability X has been identified as an active vulnerability for one or more of the computing devices 104 for which Owner A is the party responsible for taking corrective action. In this scenario, no communication response is required from Owner A. However, if Owner A does not take predetermined corrective actions within a predetermined timeframe, wherein the appropriate corrective actions and the appropriate timeframe are defined within established policies or procedures, then a ticket is transmitted to Owner A. The ticket reports the identified security vulnerability, provides instructions for taking corrective action, and requires a communicative response from Owner A, wherein the response includes the corrective actions that Owner A plans to complete to respond to Vulnerability X and the date by which the planned corrective actions will be completed by Owner A. Owner A will receive tickets regarding Vulnerability X according to a timed interval schedule, until the corrective actions are completed.

Embodiments of a notification or “ticket” may include an email, a pop-up dialog box, an alarm, a text message, an electronically generated phone call, and/or any other type of electronic notification. Data communications received by the server system 102 from the plurality of computing devices 104 may include, but are not limited to: responses to notifications. Responses to notifications may indicate planned actions to address security vulnerabilities, a proposed timeline to address security vulnerabilities, or the like.

As described herein, the third-party software applications 108 may be one or more internally maintained components (FIG. 1B) and/or may be components primarily external to the server system 102 (FIG. 1A). As shown in the embodiment of FIG. 1B, a centralized server system 102 (or other type of centralized computer system) uses external communications components and/or devices to exchange data with the third-party software applications 108, via the data communication network 106. For purposes of the present application, communications exchanged between the server system 102 and the third-party software applications 108 include the same messages associated with security vulnerabilities, although additional data exchange may be necessary to comply with appropriate communication protocols, Application Programming Interfaces (APIs) or other communication exchange mechanisms, and the like.

Data communications transmitted by the server system 102 to the third-party software applications 108 may include, but are not limited to: requests for security vulnerability data, priority level data, identifier data associated with computing devices, or the like. Data communications received by the server system 102 from the third-party software applications 108 may include, but are not limited to: security vulnerability data. priority level data, identifier data associated with computing devices, or the like.

In practice, the system 100 for enhancing data security is an automated system operable to organize large quantities of security vulnerabilities into actionable groups that can be promptly communicated and assigned to corrective action owners across the enterprise. More specifically, the system 100 for enhancing data security operates to identify potential and actual security vulnerabilities for computing devices 104 over a network 106, and to perform notification and/or ticketing operations by transmitting messages to appropriate owners responsible for resolving the particular security vulnerabilities identified. The system 100 also operates to provide a consistent interface and consistent metrics for developers at the enterprise level, using a dashboard or other “single pane of glass” interface to present a snapshot summary of data security information for computing devices 104 connected to the network 106. The system 100 further operates to determine, store, and maintain compliance data regarding potential and/or actual security vulnerabilities, in accordance with applicable laws, rules, or guidelines. Additional functionality of the system 100 for enhancing data security may include providing action item steps for owners to complete to resolve or mitigate particular security vulnerabilities, and/or performing ticketing operations according to a determined priority level for security vulnerabilities.

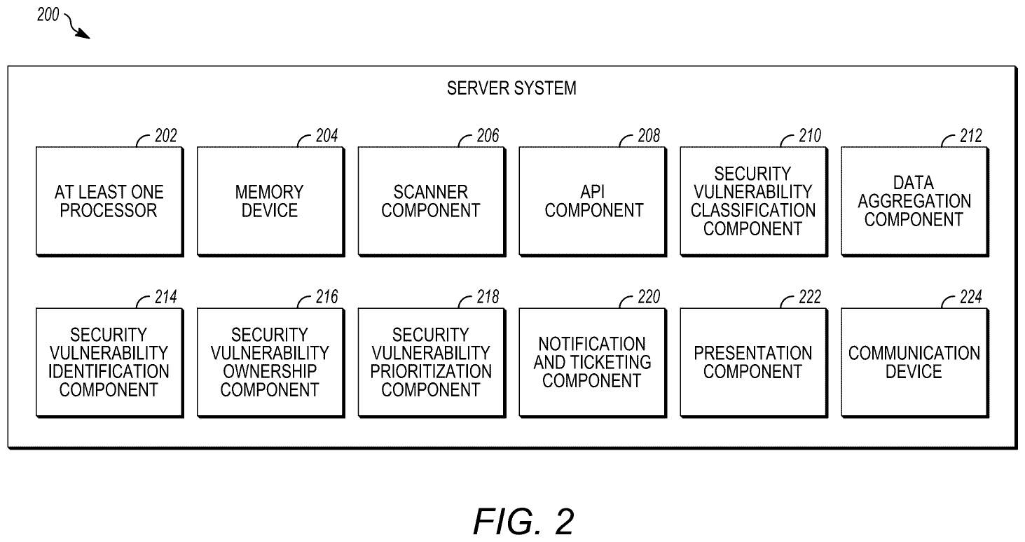

FIG. 2 is a functional block diagram of a server system 200 for use in a system for enhancing data security for computing devices over a network, in accordance with the disclosed embodiments. It should be noted that the server system 200 can be implemented as server system 102 of the system 100 depicted in FIGS. 1A-1B. In this regard, the server system 200 shows certain elements and components of the server system 102 (FIG. 1) in more detail.

The server system 200 generally includes, without limitation: at least one processor 202; a memory device 204; a scanner component 206; an Application Programming Interface (API) component 208; a security vulnerability classification component 210; a security vulnerability identification component 212; a security vulnerability ownership component 214; a security vulnerability prioritization component 216; a notification component 218; a presentation component 220; and a communication device 222. These elements and features of server system 200 may be operatively associated with one another, coupled to one another, or otherwise configured to cooperate with one another as needed to support the desired functionality-in particular, performing data security processes for at least one external computing device communicatively coupled to the server system via a network, as described herein. For ease of illustration and clarity, the various physical, electrical, and logical couplings and interconnections for these elements and features are not depicted in FIG. 2. Moreover, it should be appreciated that embodiments of the server system 200 will include other elements, modules, and features that cooperate to support the desired functionality. For simplicity, FIG. 2 only depicts certain elements that relate to the techniques for performing data security operations, as described in more detail below.

The at least one processor 202 may be implemented or performed with one or more general purpose processors, a content addressable memory, a digital signal processor, an application specific integrated circuit, a field programmable gate array, any suitable programmable logic device, discrete gate or transistor logic, discrete hardware components, or any combination designed to perform the functions described herein. In particular, the at least one processor 202 may be realized as one or more microprocessors, controllers, microcontrollers, or state machines. Moreover, the at least one processor 202 may be implemented as a combination of computing devices, e.g., a combination of digital signal processors and microprocessors, a plurality of microprocessors, one or more microprocessors in conjunction with a digital signal processor core, or any other such configuration.

The at least one processor 202 is communicatively coupled to a memory device 204. The memory device 204 is configured to store any obtained or generated data associated with data security functionality. More specifically, the memory device 204 is configured to store data related to identifying, classifying, determining status, determining ownership, performing notification and/or ticketing operations, and/or presenting reports related to security vulnerabilities.

The memory device 204 may be realized using any number of hardware and/or software elements, components, modules, or devices, as appropriate to the embodiment. Moreover, the server system 200 could include a memory device 204 integrated therein and/or a memory device 204 operatively coupled thereto, as appropriate to the particular embodiment. In practice, the memory device 204 could be realized as RAM memory, flash memory, EPROM memory, EEPROM memory, registers, a hard disk, a removable disk, or any other form of storage medium known in the art. The memory device 204 can be coupled to the at least one processor 202 such that the at least one processor 202 can read information from, and write information to, the memory device 204. In the alternative, the memory device 204 may be integral to the at least one processor 202. As an example, the at least one processor 202 and the memory device 204 may reside in a suitably configured application-specific integrated circuit (ASIC).

The scanner component 206 is suitably configured to initiate the performance of scans of external computing devices in communication with the server system 200 via a network (described below with regard to communication device 222). Initiating the performance of a scan includes communicating with a third-party software application to initiate discovery and assessment of one or more computing devices for currently active security vulnerabilities. The scanner component 206 obtains security vulnerability data for the external computing devices, via the scans. In practice, security vulnerability data applicable to a particular external computing device is obtained directly from the particular external computing device, by the scanner component 206.

The scanner component 206 initiates scans of the external computing devices. Certain embodiments of the scanner component 206 initiates the scans as part of an automated process. However, it should be appreciated that the scanner component 206 may also initiate scans in response to manual input or other non-automated prompt. Embodiments of the scanner component 206 may perform scans according to a schedule, wherein the scanning process is initiated in an automated manner. For example, the scanner component 206 may perform scans of external computing devices according to a timed-interval schedule or according to an event-triggered schedule. Some embodiments of the scanner component 206 may use a combination of a timed-interval schedule and an event-triggered schedule. As an alternative to the automated process, or in combination with the automated process, some embodiments of the scanner component 206 may initiate scans of external computing devices on an ad-hoc basis, via manual intervention into the automated process, as needed. The scanner component 206 initiates the scans of external computing devices by one or more third-party software applications, and the scanner component 206 interacts with the third-party software applications via the Application Programming Interface (API) component 208.

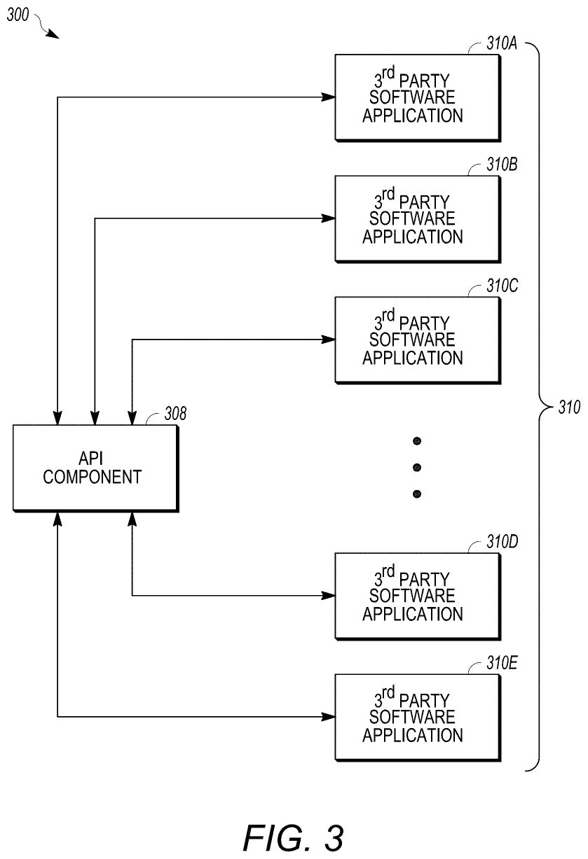

The API component 208 is configured to provide an interface for the server system 200 to interact with one or more third-party software applications, for purposes of obtaining security vulnerability data and/or performing tasks associated with data security. Functionality of the API component 208 is described in more detail below with regard to FIG. 3.

FIG. 3 illustrates the interaction between the API component 308 (referred to as API component 208 in FIG. 2) and a plurality of third-party software applications 310. The API component 308 provides an Application Programming Interface (API) that defines how a server system (or instructions, functions, or programs executed by the server system 200 as shown in FIG. 2) interacts with the applicable third-party software applications 310. In other words, the API component 308 defines communication protocols and communication rules that enable communications (e.g., requests and responses) to be transmitted, received, and applied appropriately, wherein the communications are exchanged between the server system (reference 200, FIG. 2) and one or more of the third-party software applications 310. Thus, the API component 308 acts as a “middleman”, facilitating communications between the server system (reference 200, FIG. 2) and the third-party software applications 310. Applicable third-party software applications 310 may include any application operable to perform security vulnerability scans for computing devices and/or a computer network. Applicable third-party software applications 310 are also operable to obtain information related to data security, security vulnerabilities, security vulnerability detection, security vulnerability identification, security vulnerability mitigation, compliance data related to security practices, and/or analytics related to data security and security vulnerabilities, from one or more external computing devices. Third-party software applications 310 may be selected based on included features, and for purposes of the present disclosure, may be interchangeable with any other data security software application that provides applicable data, as described herein.

Returning to FIG. 2, the security vulnerability classification component 210 is configured to “classify” or categorize security vulnerabilities according to characteristics that can be used for identification and grouping purposes. Such characteristics may include one common solution that is shared by more than one security vulnerability. Classification permits timely identification and/or grouping of security vulnerabilities based on characteristics, features, and/or attributes associated with various applicable technologies. For example, a particular operating system may require monthly installation of security patches to maintain security standards and protocols. Security Patch X may be required to avoid Security Vulnerability A and Security Vulnerability B. Here, one common characteristic of Security Vulnerabilities A and B is the commonly-required solution: Security Patch X. A second common characteristic is the commonly-used operating system, which may also be used as a classification by the security vulnerability classification component 210. The security vulnerability classification component 210 may classify Security Vulnerabilities A and B according to any characteristic, and classifying according to the common characteristics described above provides Security Vulnerability A and Security Vulnerability B with two common classifications.

The data aggregation component 212 is configured to obtain a comprehensive set of security vulnerability data associated with the external computing devices for use in generating reports (e.g., electronic records) and/or a generating a visual representation (via the presentation component 222). The data aggregation component 212 obtains the comprehensive set of security vulnerability data by obtaining and aggregating security vulnerability data associated with each of the separate and distinct external computing devices. The data aggregation component 212 may obtain security vulnerability data associated with the external computing devices from the third-party software applications via the API component 208, and/or directly from the external computing devices via the communication device 224.

As described herein, the aggregated collection of security vulnerability data may be used to create and store electronic records. The aggregated collection of security vulnerability data may also be used to create and present a snapshot, dashboard, or other type of aggregated summary presentation from a combined set of sources. Such a summary provides a consolidated view of security vulnerability data, trends, ownership, priority level, corrective actions and associated stages of completion, and the like. The aggregated collections can further rank the security vulnerability within the snap shot such that a less severe security vulnerability is ranked below other security vulnerabilities that have greater potential for exploit.

The security vulnerability identification component 214 is configured to identify current security vulnerabilities of external computing devices communicatively coupled to the server system 200 over a network. The security vulnerability identification component 214 functions cooperatively with the scanner component 206, the API component 208, and the security vulnerability classification component 210 to (i) obtain security vulnerability data from the external computing devices, and to (ii) identify current security vulnerabilities based on classification data.

As described previously, the security vulnerability classification component 210 classifies individual security vulnerabilities according to characteristics, and characteristics may be associated with one or more keywords or phrases. The security vulnerability identification component 214 may detect the presence of a characteristic within the data obtained from an external computing device. In some embodiments, the security vulnerability identification component 214 may detect the characteristic using one or more keywords or phrases common to security vulnerabilities associated with that characteristic. In other embodiments, the security vulnerability identification component 214 may detect the characteristic using output from the API (obtained by the API component 208). For example, output from the API may identify a solution for a security vulnerability, wherein the solution may be used as a classification. As another example, output from the API may include references to an owner of a security vulnerability, wherein the owner may be associated with one or more particular classifications.

The security vulnerability ownership component 216 is configured to identify one or more current “owners” of an identified security vulnerability. An owner is the party responsible for taking corrective action to resolve one or more particular security vulnerabilities. In other words, the owner is the person or persons assigned a duty to correct particular security vulnerabilities. Corrective actions may include, but are not limited to: executing software security “patches” and/or updates, submitting a request for technical assistance to correct the security vulnerability, applying mitigating solutions, altering computing system configurations, closing ports of a computing device, changing firewall settings, or the like.

An owner may be an individual person or a group of people. As one example, a department or team in an enterprise environment may be an owner or responsible party for a particular security vulnerability. As another example, a specifically named person may be the owner or responsible party. As a third example, the person holding a particular title or position in an enterprise environment may be the owner or responsible party. The owner may be responsible for a particular category of security vulnerability (e.g., networking vulnerabilities, operating system vulnerabilities, etc.), or the owner may be responsible for security vulnerabilities occurring on particular computing devices within the owner's purview.

During operation, the security vulnerability ownership component 216 identifies current ownership of a particular security vulnerability by accessing (via the communication device 222) a database that stores security vulnerability data and associated ownership data, performing a lookup based on the detected and identified security vulnerability, and determining a current owner associated with the identified security vulnerability based on the information obtained in the database.

The security vulnerability prioritization component 218 is configured to prioritize actual security vulnerabilities associated with particular external computing devices communicating with the server system 200 over a network. Each actual security vulnerability is detected as being a currently existing security vulnerability for at least one external computing device, and the security vulnerability prioritization component 218 determines a priority level based on one or more factors, which may include, but are not limited to: age of security vulnerability, priority level as determined by one or more third-party software applications (reference 108, FIGS. 1A-1B), and/or ownership data associated with the security vulnerability.

The notification and ticketing component 220 is configured to create and initiate transmission of (via the communication device 222) one or more notifications and/or “tickets” regarding actual security vulnerabilities. In other words, the notification and ticketing component 220 performs (i) initial notification operations, wherein an informal notice is generated as a message for situational awareness and potential early corrective action purposes, and (ii) “ticketing” operations, wherein an official communication (i.e., a ticket) is generated to inform an owner of the security vulnerability and to provide instructions for taking corrective action. Notifications and tickets are configured based upon classification, solution, owner, and other applicable objectives, as needed for the particular application. The notification and ticketing component 220 initiates transmission of notifications or tickets to a current owner or updated current owner, as identified via the ownership component 216. In some embodiments, the notification and ticketing component 220 generates one notification or ticket for each identified security vulnerability. However, in some embodiments, the notification and ticketing component 220 generates a single notification or ticket for a plurality of security vulnerabilities associated with the same owner or group of owners. As described in more detail below, the notification and ticketing component 220 may perform notification and/or ticketing operations according to an event-triggered schedule, a timed interval schedule, and/or a combination of both. In some embodiments, timing of the generated notification and/or ticket may be based on a priority level (as determined by the prioritization component 218).

The presentation component 222 is configured to generate and provide graphical elements and text for presentation to a user of the server system 200 via any suitable display device (not shown). For this purpose, the presentation component 222 may transmit visual elements via the communication device 224 or other direct connection to the server system 200. In other words, the presentation component 222 is configured to work cooperatively with one or more display devices (not shown) communicatively coupled to the central server system 200 to provide visual representations of current and/or past security vulnerability data. Such display devices may be internal to the server system 200 or external to the server system 200. The presentation component 222 generates and provides graphical elements and text associated with security vulnerabilities, priority level, ownership, and the like. In some embodiments, the presentation component 222 is configured to render one or more graphical user interfaces adapted for user interaction with security vulnerability data, ownership data, external computing device identification data, or the like.

In practice, the scanner component 206, the API component 208, the security vulnerability classification component 210, the data aggregation component 212, the security vulnerability identification component 214, the security vulnerability ownership component 216, the security vulnerability prioritization component 218, the notification and ticketing component 220, and/or the presentation component 222, may be implemented with (or cooperate with) the at least one processor 202 to perform at least some of the functions and operations described in more detail herein. In this regard, the scanner component 206, the API component 208, the security vulnerability classification component 210, the data aggregation component 212, the security vulnerability identification component 214, the security vulnerability ownership component 216, the security vulnerability prioritization component 218, the notification and ticketing component 220, and/or the presentation component 222, may be realized as suitably written processing logic, application program code, or the like.

The communication device 224 is configured to communicate data between the server system 200 and at least one external computing device, and at least one database storing ownership data. In embodiments where the third-party software applications (reference 310, FIG. 3) reside in a location external to the server system 200 (i.e., a computer system separate and distinct from the server system 200), then the communication device 224 is configured to communicate data between the server system 200 and the separate and distinct computer system, such that communications between the server system 200 and the third-party software applications is enabled. The communication device 224 may transmit and receive communications over a wireless local area network (WLAN), the Internet, a satellite uplink/downlink, a cellular network, a broadband network, a wide area network, or the like. As described in more detail below, data received by the communication device 224 may include, without limitation: external computing device scan data, security vulnerability data, priority level data, associations of classification data to particular security vulnerabilities, ownership data, and the like. Data provided by the communication device 224 may include, without limitation: security vulnerability classification data, requests for scans of external computing devices, and the like.

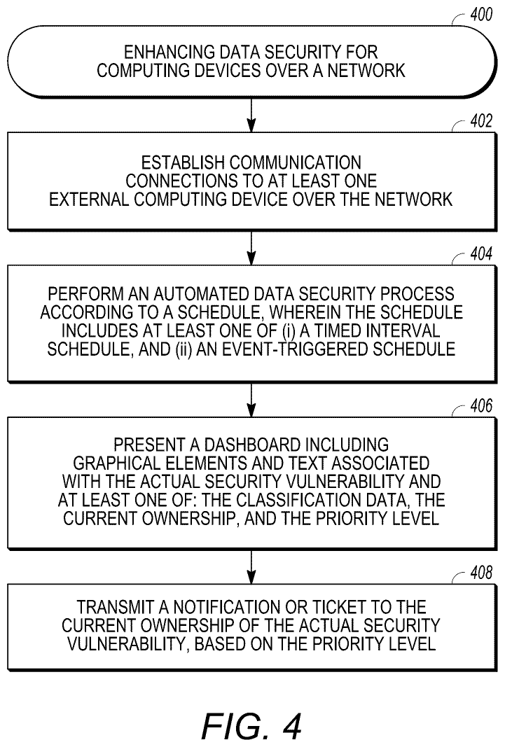

FIGS. 4-9 are flow charts illustrating embodiments of processes for enhancing data security and/or data compliance for computing devices over a network. As described herein, exemplary embodiments of processes 400-900 may be implemented in an enterprise computing environment. However, embodiments of processes 400-900 may be implemented in any computing environment, as needed for a particular application. The various tasks performed in connection with processes 400-900 may be performed by software, hardware, firmware, or any combination thereof. For illustrative purposes, the included descriptions of processes 400-900 may refer to elements mentioned herein in connection with FIGS. 4-9. In practice, portions of processes 400-900 may be performed by different elements of the described system. It should be appreciated that processes 400-900 may include any number of additional or alternative tasks, the tasks shown in FIGS. 4-9 need not be performed in the illustrated order, and processes 400-900 may be incorporated into a more comprehensive procedure or process having additional functionality not described in detail herein. Moreover, one or more of the tasks shown in FIGS. 4-9 could be omitted from certain embodiments of processes 400-900 as long as the intended overall functionality remains intact.

FIG. 4 is a flow chart that illustrates an embodiment of a process 400 for enhancing data security for computing devices over a network. First, the process 400 establishes communications connections to at least one external computing device over the network (step 402). The communications connections are established from a centralized computer system, such as the embodiment shown in FIG. 2 (e.g., a server system 200).

In embodiments where the third-party software applications exist in a location external to the centralized computer system (e.g., server system 102, FIG. 1) communications connections may also be established between the centralized computer system and the computer(s) storing, maintaining, and operating the third-party software applications. In this way, the process 400 establishes communication connections (i) to the external computing devices that are directly affected by security vulnerabilities, and (ii) to any applicable third-party software application that obtains, aggregates, and/or analyzes any subset of relevant security vulnerability data from the external computing devices, wherein the security vulnerability data and/or analysis is available to the centralized computer system. The process 400 establishes the communications connections for purposes of obtaining security vulnerability data, dynamically and in real-time.

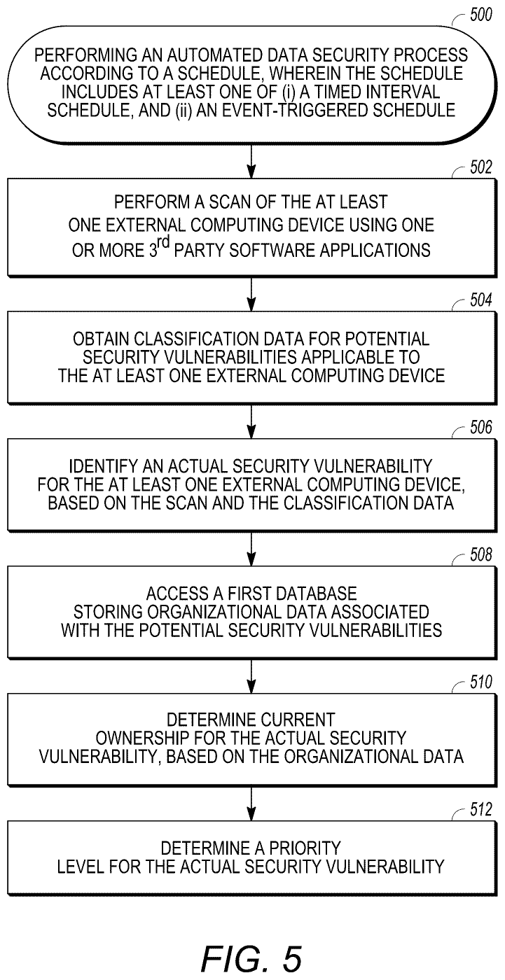

Next, the process 400 performs an automated data security process according to a schedule, wherein the schedule includes at least one of: (i) a timed interval schedule, and (ii) an event-triggered schedule (step 404). One suitable methodology for performing an automated data security process according to a schedule is described below with reference to FIG. 5.

Although the process 400 may be implemented in any computing environment in which a centralized computer system (e.g., server system 102 of FIG. 1A-1B), certain exemplary embodiments of the process 400 are implemented in an enterprise computing environment. Challenges encountered in an enterprise computing environment include providing centralized detection, identification, reporting, response, mitigation, and/or solutions for a potentially large quantity of security vulnerabilities, due to the potentially large quantity of computing devices typically operating over a shared network. Here, the process 400 performs data security procedures in an automated manner, such that manual intervention is not required to initiate the detection, identification, reporting, response, mitigation, and/or solutions for any applicable security vulnerabilities. Automated data security procedures are beneficial to such an enterprise system handling a large quantity of security vulnerabilities. Some embodiments of the process 400 may automatically initiate such data security procedures according to a timed interval schedule, wherein the data security procedures are triggered daily, weekly, monthly, or according to any predetermined period of time. Some embodiments of the process 400 may automatically initiate such data security procedures according to an event-triggered schedule, wherein the data security procedures commence when a particular event occurs. For example, if a failure or error condition occurs in a particular computing device, occurrence of the failure or error condition may trigger commencement of the automated data security procedures.

The process 400 presents a dashboard including graphical elements and text associated with an identified, actual security vulnerability and at least one of the classification data, the current ownership, and the priority level (step 406). Once data security procedures have been performed (step 404), the process 400 provides a visual representation of current security vulnerability data.

Security vulnerability reporting is based on aggregated data obtained from a plurality of secondary sources (e.g., third-party software applications), and may be presented as part of a snapshot, dashboard, or other type of aggregated summary presentation from a combined set of sources. In this way, the process 400 provides a consolidated view (i.e., “a single pane of glass”) of security vulnerability data, trends, ownership, priority level, corrective actions and associated stages of completion, and the like. The graphical and/or text-based representation of the current and past security vulnerability conditions includes the consolidated view (i.e., summary, snapshot, dashboard, “single pane of glass”, or other aggregated summary presentation). The consolidated view can be generated from electronic records.

Here, the process 400 presents the security vulnerability data in a visual manner for user consumption and, in some embodiments, for user interaction. The dashboard provides a consolidated summary view or snapshot view of the security vulnerability data, obtained from a plurality of secondary sources (e.g., third-party software applications). In this way, the dashboard is one graphical interface that is presented as a “single pane of glass” for analysts, developers, administrators, and other users of the centralized server system to view a condensed outline of security vulnerability data for the entire enterprise environment. Alternatively, the process 400 may provide the dashboard to present a summary of security vulnerability data applicable to one particular department, one particular team, and/or any one particular subset of the computing environment. Thus, the process 400 presents an overview of current security statuses and current security vulnerability details in one location.

Current security vulnerability data may include any current security vulnerabilities that have been identified, and past or potential security vulnerabilities for one or more of the external computing devices. A security vulnerability may be defined as any weakness in computing device security protocols and/or practices resulting in any type of exposure which may be exploited. Corrective actions to address security vulnerabilities may include, but are not limited to: updating security software for applicable computing devices, implementing additional software-based security processes (e.g., incorporating additional and/or more advanced encryption techniques), implementing additional non-software-based security processes (e.g., increasing internal controls for users, educating users regarding phishing and other network infiltration techniques, etc.), and the like. Security vulnerability data may also include characteristics of applicable security vulnerabilities, a priority level for each identified security vulnerability, ownership data for one or more identified security vulnerabilities, potential mitigation strategies associated with one or more security vulnerabilities, or the like.

The overview presented as a dashboard may include any number of identified security vulnerabilities. In the example described by process 400, one particular security vulnerability is identified and presented via the dashboard, and security vulnerability details associated with the identified security vulnerability are presented via the dashboard as well. Security vulnerability details may include one or more of: classification data, current ownership data, and/or a priority level for the security vulnerability.

Classification data may include any security vulnerability characteristics or attributes used to “classify”, group, categorize, or otherwise sort security vulnerabilities into applicable subsets. Classification permits timely identification and/or grouping of security vulnerabilities based on characteristics, features, and/or attributes associated with various applicable technologies. As discussed in one previous example, a particular operating system may require monthly installation of security patches to maintain security standards and protocols. Security Patch X may be required to avoid Security Vulnerability A and Security Vulnerability B. Here, one common characteristic of Security Vulnerabilities A and B is the commonly-required Security Patch X. A second common characteristic is the commonly-used operating system. Although a common security patch and/or a common operating system are described here as examples, it should be appreciated that classification data may include any attribute or characteristic of a security vulnerability.

Current ownership data identifies one or more parties currently bearing responsibility for an identified security vulnerability. An owner is the party responsible for taking corrective action to resolve one or more particular security vulnerabilities. In other words, the owner is the person or persons assigned a duty to correct particular security vulnerabilities. Corrective actions may include, but are not limited to: executing software security “patches” and/or updates, submitting a request for technical assistance to correct the security vulnerability, or the like.

A priority level is determined based on one or more factors, which may include, but are not limited to: age of security vulnerability, priority level as determined by one or more third-party software applications (reference 108, FIGS. 1A-1B), and/or ownership data associated with the security vulnerability.

The process 400 transmits a notification or ticket to the current ownership of the identified, actual security vulnerability, based on the priority level (step 408). Here, the process 400 notifies a current owner that a particular security vulnerability exists, for purposes of initiating corrective action by the owner. The process 400 may generate and/or transmit notifications according to the priority level. For example, the notification for a high priority security vulnerability may include visually distinguishing graphics or colors indicating the priority level. Additionally, notifications for a high priority security vulnerability may be transmitted on a more frequent basis than notifications for a low priority security vulnerability. Alternatively, a notification for a high priority security vulnerability may include a more intrusive or interrupting message, such as an alarm or dialog box that pops up or overlays current graphics on the owner's computer screen. Low priority notifications may be associated with an email or text message.

FIG. 5 is a flow chart that illustrates an embodiment of a process 500 for performing an automated data security process according to a schedule that includes at least one of a timed interval schedule and an event-triggered schedule. It should be appreciated that the process 500 described in FIG. 5 represents one embodiment of step 404 described above in the discussion of FIG. 4, including additional detail.

The process 500 performs a scan of the at least one external computing device using one or more third-party software applications (step 502). Third-party software applications may include any type of executable instructions that obtain security vulnerability data from external computing devices on the network. Security vulnerability data may include: currently existing security vulnerabilities and any associated characteristics, identifiers or keywords, priority level factors, or the like.

Exemplary embodiments of third-party software applications may perform additional security vulnerability data aggregation and/or analysis during and/or after scanning the external computing devices. For example, a third-party software application may identify not only current security vulnerabilities, but may also identify past security vulnerabilities that have been resolved and/or identify potential security vulnerabilities. As another example, a third-party software application may also determine a priority level for any identified security vulnerability, wherein the priority level indicates urgency and/or importance of timely response and corrective action by the owner. In embodiments where the third-party software application provides additional data aggregation and/or analysis, the process 500 obtains the additional data with the scan data.

The process 500 obtains classification data for potential security vulnerabilities applicable to the at least one external computing device (step 504). Potential security vulnerabilities are security vulnerabilities that may become applicable to the external computing devices at a future point in time. Classification data includes groupings or categories of security vulnerabilities according to particular characteristics. For example, two (or more) security vulnerabilities may be categorized according to a characteristic or trait common to the two security vulnerabilities. Certain embodiments of the classification data may include keywords indicating a category of particular security vulnerabilities. In an enterprise computing environment that includes a large quantity of external computing devices, classification permits timely identification and/or grouping of security vulnerabilities based on characteristics or features common to sub-groups of the external computing devices. Some embodiments of the process 500 may obtain the classification data via external database lookup. However, it should be appreciated that the process 500 may obtain the classification data from any internal or external data storage medium.

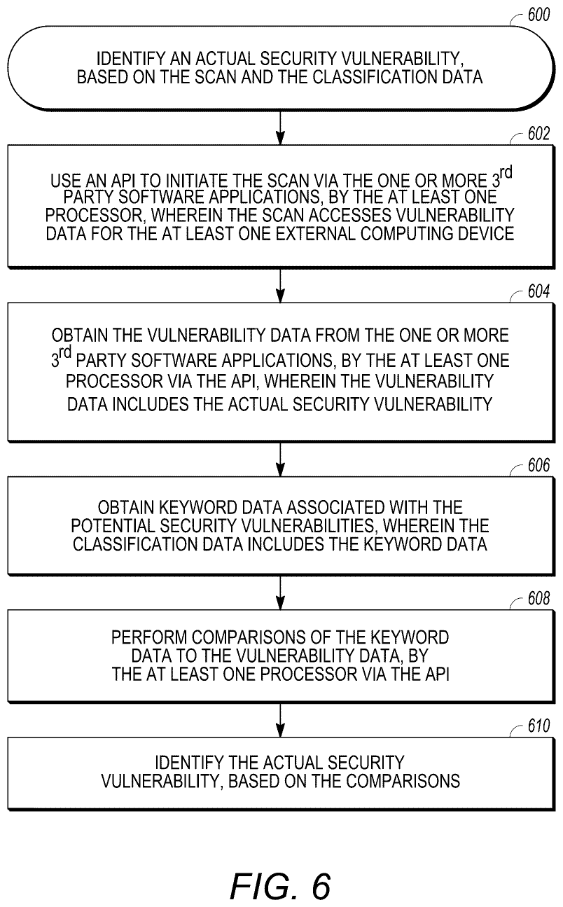

The process 500 identifies an actual security vulnerability for the at least one external computing device, based on the scan and the classification data (step 506). Here, the process 500 uses the current, actual data obtained via the scan (step 502) and potential security vulnerability data included in the classification data (step 504) to identify an actual security vulnerability. One suitable methodology for identifying an actual security vulnerability for at least one external computing device is described below with reference to FIG. 6.

The process 500 accesses a first database storing organizational data associated with the potential security vulnerabilities (step 508). Organizational data provides information regarding people or groups associated with particular computing device identifiers, particular types of computing devices, particular operating systems, particular hardware components and/or software components, or the like. Organizational data may include, without limitation, organizational charts, lists, registries, or other data structures or documentation.

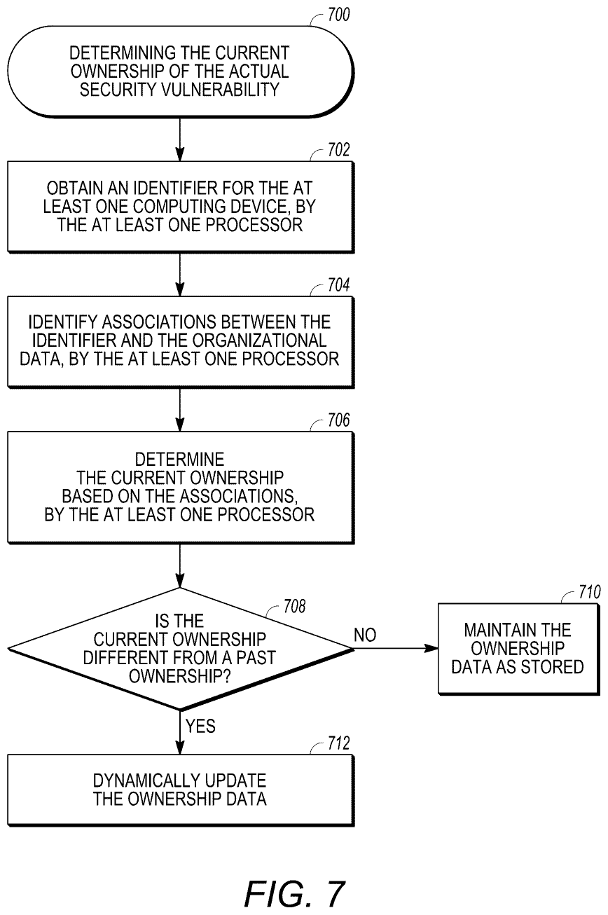

The process 500 determines current ownership for the actual security vulnerability, based on the organizational data (step 510). One suitable methodology for determining current ownership for an actual security vulnerability is described below with reference to FIG. 7. Ownership is typically associated with the particular computing device associated with the actual security vulnerability. Current ownership indicates the party or parties responsible for performing actions to resolve the actual security vulnerability.

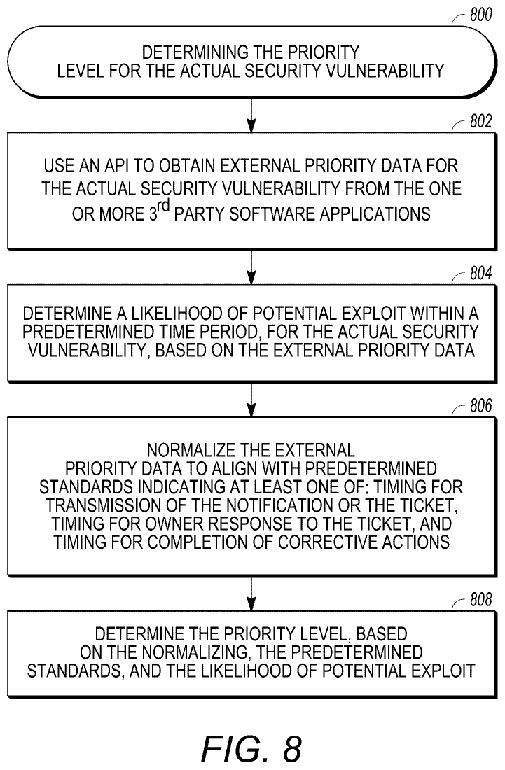

The process 500 determines a priority level for the actual security vulnerability (step 512). One suitable methodology for determining a priority level for an actual security vulnerability is described below with reference to FIG. 8. Security vulnerabilities may be associated with a particular priority level that indicates a degree of urgency to reach a resolution to the issue creating the vulnerability. Typical embodiments of priority levels may include high, medium, and low levels of urgency or criticality. Other embodiments may include additional or fewer levels of urgency or criticality. The process 500 may determine the priority level based on one or more factors, which may include, but are not limited to: age of security vulnerability, criticality as determined by one or more third-party software applications (reference 108, FIGS. 1A-1B), and/or ownership data associated with the security vulnerability. Priority levels may be used to determine timing, number, and/or type of notifications and/or tickets presented or transmitted to the identified owner, such that the owner is informed of the urgency of resolving the underlying issue to eliminate or mitigate the actual security vulnerability.

FIG. 6 is a flow chart that illustrates an embodiment of a process 600 for identifying an actual security vulnerability, based on a scan and classification data. It should be appreciated that the process 600 described in FIG. 6 represents one embodiment of step 506 described above in the discussion of FIG. 5, including additional detail.

The process 600 uses an Application Programming Interface (API) to initiate the scan via the one or more third-party software applications, by the at least one processor, wherein the scan accesses vulnerability data for the at least one external computing device (step 602). The API is pre-configured to enable communications with at least one of the third-party software applications. One or more APIs may be used, as appropriate.

The process 600 obtains the vulnerability data from the one or more third-party software applications, by the at least one processor via the API, wherein the vulnerability data includes the actual security vulnerability (step 604). Here, the process 600 obtains actual and current data regarding (i) the at least one external computing device, and (ii) any current security vulnerabilities associated with the external computing device.

The process 600 obtains keyword data associated with the potential security vulnerabilities, wherein the classification data includes the keyword data (step 606). As described previously, classification data for potential security vulnerabilities may be obtained from any source, and the classification data may include keyword data associated with the potential security vulnerabilities. For example, each security vulnerability of a particular category may be associated with one or more particular keywords. Here, the process 600 obtains the one or more particular keywords for use in identifying actual, current security vulnerabilities.

The process 600 performs comparisons of the keyword data to the vulnerability data, by the at least one processor via the API (step 608). Here, the process 600 compares the obtained keyword data to the vulnerability data obtained in step 602. The process 600 identifies the actual security vulnerability based on the comparisons (step 610).

FIG. 7 is a flow chart that illustrates an embodiment of a process 700 for determining current ownership of an actual security vulnerability. It should be appreciated that the process 700 described in FIG. 7 represents one embodiment of step 510 described above in the discussion of FIG. 5, including additional detail.

First, the process 700 obtains an identifier for the at least one computing device, by the at least one processor (step 702). Identifiers may be any appropriate label, classification, and/or other indicator of an individual computing device or group of computing devices. The identifier may include a name, an Internet Protocol (IP) address, or the like.

The process 700 identifies associations between the identifier and the organizational data, by the at least one processor (step 704). As described previously, the organizational data is obtained from any appropriate internally stored and/or externally stored source. Here, the process 700 may determine one or more persons, teams or groups associated with the identifier.

The process 700 determines the current ownership based on the associations, by the at least one processor (step 706). Ownership indicates the party or parties responsible for performing actions to resolve, potentially resolve, or mitigate damage from, the actual security vulnerability for the particular computing device. Current ownership indicates a point of contact for action item notifications to resolve the actual security vulnerability for the particular computing device.

The process 700 then determines whether the current ownership is different from a past ownership (decision 708) Ownership data is stored and maintained, for purposes of directing notifications to the contact information of the appropriate party. When the current ownership is not different from a past ownership (the “No” branch of 708), then the process 700 maintains the ownership data as stored (step 710). Here, no changes are made to the stored ownership data. However, when the current ownership is different from a past ownership (the “Yes” branch of 708), then the process 700 dynamically updates the ownership data (step 712). Here, the process 700 updates the stored ownership data, in real-time, as the current ownership data is determined to have changed.

FIG. 8 is a flow chart that illustrates an embodiment of a process 800 for determining a priority level for an actual security vulnerability. It should be appreciated that the process 800 described in FIG. 8 represents one embodiment of step 512 described above in the discussion of FIG. 5, including additional detail.

The process 800 uses an API to obtain external priority data for the actual security vulnerability from the one or more third-party software applications (step 802). The external priority data may include any data associated with severity of the actual security vulnerability, as determined by an external source, such as a third-party software application or other outside, external, third-party, and/or independent data source. In some embodiments, the external priority data may include a third-party generated prioritization for the actual security vulnerability. In this scenario, the process 800 may obtain a previously determined, previously calculated, and/or previously computed prioritization of the actual security vulnerability. In some embodiments, the external priority data may include other factors or information indicating priority level For example, an age of the actual security vulnerability, or a severity of security vulnerability as determined by one or more third-party software applications (reference 108, FIGS. 1A-1B).

The process 800 determines a likelihood of potential exploit within a predetermined time period, for the actual security vulnerability, based on the external priority data (step 804). The likelihood of potential exploit is indicated by the external priority data. For example, a previously determined prioritization may indicate a likelihood of exploit, as determined by an outside source (e.g., a third-party software application). As another example, an increased age or older age of the actual security vulnerability may indicate a higher likelihood of exploit. The likelihood of potential exploit may be presented as a value from a numerical scale (e.g., 1-10, 1-50, 1-100), as a point or level on a different scale (e.g., high/medium/low levels), as a value from a binary scale (e.g., true/false, likely/unlikely), or as a percentage value from a percentage scale (e.g., 50% likelihood of exploit).

The likelihood of exploit is applicable for a predetermined time period. More specifically, a likelihood or probability that the actual security vulnerability will be exploited may be applicable for thirty (30) days, sixty (60) days, ninety (90) days, or another relevant time period associated with the actual security vulnerability and the likelihood of exploit. The process 800 may obtain or determine (at an earlier time) the predetermined time period. In embodiments where a previously determined prioritization from an outside source is used, the process 800 also obtains the predetermined time period from the outside source (e.g., third-party software application). In embodiments where the process 800 determines the likelihood of potential exploit based on factors or information obtained from the outside source, the process 800 may use a predetermined time period obtained from an outside source or may use a predetermined time period that the process 800 has previously computed and stored.

The process 800 normalizes the external priority data to align with predetermined standards indicating at least one of: timing for transmission of the notification or ticket, timing for owner response to the ticket, and timing for completion of corrective actions (step 806).

Normalization of the external priority data includes “translating” mapping, or otherwise altering the external priority data for applicability to an internal system. In other words, data obtained from an outside source or third-party is adjusted for compatibility and use within an internal system.

As discussed above, the external priority data may include a prioritization from an outside source, and other factors or information indicating severity of the actual security vulnerability. The process 800 applies predetermined standards to the prioritization and/or other factors to make adjustments and align the external priority data to the internal system. For example, as discussed above, a likelihood of exploit provided by a third-party software application as part of a set of external priority data may be 50% for the next 30 days. In one scenario, the process 800 may translate the 50% likelihood to a Priority-1 (P1) likelihood on an internal scale that includes a range from Priority-0 (P0: highest priority) to Priority-3 (P3: lowest priority). In this scenario, the internal scale differs from the likelihood scale used by the outside source of external priority data, and thus, the process 800 adjusts the external priority data such that the external priority data may be used in the internal system. As another example, an age of the actual security vulnerability provided by an outside source as part of a set of external priority data may be six (6) months old. In this scenario, the age of the actual security vulnerability may indicate an increased severity due to the extended period of time that the actual security vulnerability has existed, resulting in a prolonged period of exposure to potential security threats for an associated computing device.

The predetermined standards specify scale levels or values of the external prioritization and other factors, and corresponding scale levels or values within the internal system. Thus, the process 800 uses a predetermined mapping of external priority data to the predetermined standards, to normalize the external priority data.

The process 800 then determines the priority level, based on the normalizing, the predetermined standards, and the likelihood of potential exploit (step 808). As described previously, the process 800 may determine the priority level based on one or more factors, which may include, but are not limited to: age of security vulnerability and severity of security vulnerability as determined by one or more third-party software applications (reference 108, FIGS. 1A-1B). Ownership data associated with the security vulnerability may also be indicative of priority level. For example, a particular enterprise team or individual owner may use computing devices associated with a high priority, or may perform a particular type of work associated with a high priority. Priority levels may be used to determine timing, number, and/or type of notifications or tickets presented or transmitted to the identified owner, such that the owner is informed of the urgency of resolving the underlying issue to eliminate or mitigate the actual security vulnerability.

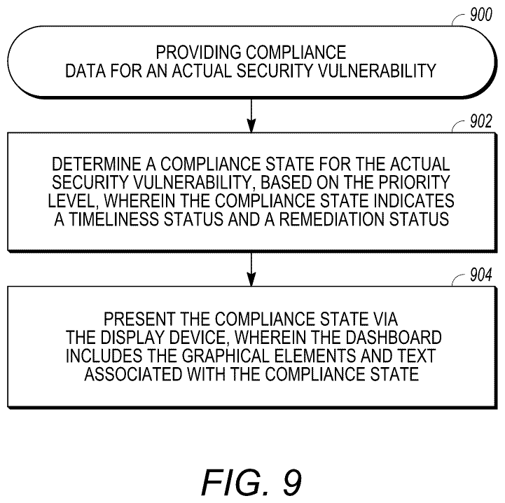

FIG. 9 is a flow chart that illustrates an embodiment of a process 900 for providing compliance data for an actual security vulnerability. Compliance data indicates whether action items in support of resolution, partial resolution, and/or mitigation of results of the actual security vulnerability, are performed or in a state of partial performance. Compliance standards or rules may be informal or formal, and may include internally recognized standards implemented by an enterprise organization and/or any type of governing laws (local, state, federal, foreign, or the like) applicable to the situation. Compliance standards may be preconfigured to reflect rules or laws established by the enterprise organization and/or the appropriate governmental authority.

The process 900 determines a compliance state for the actual security vulnerability, based on the priority level wherein the compliance state indicates a timeliness status and a remediation status (step 902). Here, the process 900 determines whether the actual security vulnerability is a new or recently identified security vulnerability (i.e., the age of the security vulnerability), and the appropriate actions to be taken to resolve the security vulnerability. The remediation status indicates whether any subset of the appropriate actions have been taken to resolve or mitigate the actual security vulnerability, based on the compliance standards or rules applied. The timeliness status indicates whether the appropriate actions have been taken, based on the age and the compliance standards or rules applied.

The process 900 presents the compliance state via the display device, wherein the dashboard includes the graphical elements and text associated with the compliance state (step 904). Some embodiments of the process 900 may present the compliance data as part of a “dashboard” or other summarized or snapshot data set. In this scenario, a dashboard includes graphical elements and text associated with the compliance state. In certain embodiments, the process 900 stores and maintains the compliance data. Thus, the process 900 may obtain, present, and/or maintain compliance data for documentation and/or auditing purposes.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

The preceding description refers to elements or nodes or features being “connected” or “coupled” together. As used herein, unless expressly stated otherwise, “coupled” means that one element/node/feature is directly or indirectly joined to (or directly or indirectly communicates with) another element/node/feature, and not necessarily mechanically. Likewise, unless expressly stated otherwise, “connected” means that one element/node/feature is directly joined to (or directly communicates with) another element/node/feature, and not necessarily mechanically. Thus, although the schematic shown in FIGS. 1A-1B and 2-4 depict exemplary arrangements of elements, additional intervening elements, devices, features, or components may be present in an embodiment of the depicted subject matter.

In addition, certain terminology may also be used in the preceding description for the purpose of reference only, and thus are not intended to be limiting. For example, terms such as “upper”, “lower”, “above”, and “below” refer to directions in the drawings to which reference is made. Terms such as “front”, “back”, “rear”, “side”, “outboard”, and “inboard” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second”, and other such numerical terms referring to structures do not imply a sequence or order unless clearly indicated by the context.

For the sake of brevity, conventional techniques related to signal processing, data transmission, signaling, network control, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

The term “component” may refer to any part, group of parts, sub-section, or the like, of an apparatus, device, or system, as described herein. Components may include hardware components, software components, and/or any combination of hardware and software components. Some of the functional units described herein have been referred to as “components” in order to more particularly emphasize their implementation independence. For example, functionality referred to herein as a component may be implemented wholly, or partially, as a hardware circuit comprising custom VLSI circuits or gate arrays, off-the-shelf semiconductors such as logic chips, transistors, or other discrete components. A component may also be implemented in programmable hardware devices such as field programmable gate arrays, programmable array logic, programmable logic devices, or the like. Components may also be implemented in software for execution by various types of processors. An identified component of executable code may, for instance, comprise one or more physical or logical components of computer instructions that may, for instance, be organized as an object, procedure, or function. Nevertheless, the executables of an identified component need not be physically located together, but may comprise disparate instructions stored in different locations that, when joined logically together, comprise the component and achieve the stated purpose for the component. Indeed, a component of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set, or may be distributed over different locations including over different storage devices, and may exist, at least partially, merely as electronic signals on a system or network.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method for enhancing data security for computing devices over a network, the method comprising:
establishing communication connections to at least one external computing device over the network, by at least one processor communicatively coupled to a memory device, wherein the computing devices include the at least one external computing device; and
performing an automated data security process according to a schedule, wherein the automated data security process comprises:
performing a scan of the at least one external computing device using one or more third-party software applications, by the at least one processor via the network;
obtaining classification data for potential security vulnerabilities applicable to the at least one external computing device;
identifying an actual security vulnerability for the at least one external computing device, based on the scan and the classification data, by the at least one processor, wherein the potential security vulnerabilities include the actual security vulnerability;
accessing a first database storing organizational data associated with the potential security vulnerabilities, by the at least one processor via the network;
determining current ownership for the actual security vulnerability, by the at least one processor, based on the organizational data; and
determining a priority level for the actual security vulnerability, by the at least one processor;
presenting a dashboard including graphical elements and text associated with the actual security vulnerability and at least one of: the classification data, the current ownership, and the priority level, via a display device communicatively coupled to the at least one processor; and
transmitting a notification or ticket to the current ownership of the actual security vulnerability, based on the priority level, by the at least one processor via the communication connections.

2. The method of claim 1, wherein identifying an actual security vulnerability based on the scan and the classification data, further comprises:
using an Application Programming Interface (API) to initiate the scan via the one or more third-party software applications, by the at least one processor, wherein the scan accesses vulnerability data for the at least one external computing device; and
obtaining the vulnerability data from the one or more third-party software applications, by the at least one processor via the API, wherein the vulnerability data includes the actual security vulnerability.

3. The method of claim 2, wherein obtaining the classification data further comprises obtaining keyword data associated with the potential security vulnerabilities; and
wherein the method further comprises:
performing comparisons of the keyword data to the vulnerability data, by the at least one processor via the API; and
identifying the actual security vulnerability, based on the comparisons.

4. The method of claim 1, further comprising:
performing a plurality of scans of the at least one external computing device according to a timed interval schedule, by the at least one processor using the one or more third-party software applications, wherein the plurality of scans includes the scan, and wherein the schedule includes the timed interval schedule; and
identifying actual security vulnerabilities according to the timed interval schedule, wherein the actual security vulnerabilities includes the actual security vulnerability.

5. The method of claim 4, further comprising:
determining whether the current ownership is different from a past ownership, by the at least one processor, according to the timed interval schedule; and
when the current ownership is different from the past ownership, dynamically updating the current ownership to generate an updated current ownership, according to the timed interval schedule.

6. The method of claim 1, wherein determining the current ownership for the actual security vulnerability, further comprises:
obtaining an identifier for the at least one computing device, by the at least one processor;
identifying associations between the identifier and the organizational data, by the at least one processor; and
determining the current ownership based on the associations, by the at least one processor.

7. The method of claim 1, wherein determining the priority level for the actual security vulnerability further comprises:
using an Application Programming Interface (API) to obtain external priority data for the actual security vulnerability from the one or more third-party software applications;
determining a likelihood of potential exploit within a predetermined time period, for the actual security vulnerability, based on the external priority data; and
determining the priority level based on the likelihood of potential exploit.

8. The method of claim 7, further comprising:
normalizing the external priority data to align with predetermined standards indicating at least one of: timing for transmission of a ticket, timing for owner response to the ticket, and timing for completion of corrective actions; and
determining the priority level based on the normalizing, the predetermined standards, and the likelihood of potential exploit.

9. The method of claim 7, further comprising:
determining a compliance state for the actual security vulnerability, based on the priority level, wherein the compliance state indicates a timeliness status and a remediation status; and
presenting the compliance state via the display device, wherein the dashboard includes the graphical elements and text associated with the compliance state.

10. The method of claim 9, wherein the compliance state comprises one of: a remediated state, an unremediated compliant state, an unremediated non-compliant state, or an overdue critical state.

11. The method of claim 1, further comprising:
associating the actual security vulnerability to corresponding visual effects, based on the priority level, by the at least one processor, wherein the corresponding visual effects include at least one of a color scheme, particular graphical elements or text, and font variations; and
presenting one or more reports using the corresponding visual effects, by the at least one processor, wherein the one or more reports includes at least one of a chart and a graph, and wherein the graphical elements and text include the one or more reports.

12. A system for enhancing data security for computing devices over a network, the system comprising:
a memory component;
a communication device configured to establish communication connections to at least one external computing device over the network, wherein the computing devices include the at least one external computing device; and
at least one processor communicatively coupled to the memory component and the communication device, the at least one processor configured to:
perform an automated data security process according to a schedule, wherein the automated data security process comprises:
performing a scan of the at least one external computing device using one or more third-party software applications, via the communication device using the communication connections;
obtaining classification data for potential security vulnerabilities applicable to the at least one external computing device;
identifying an actual security vulnerability for the at least one external computing device, based on the scan and the classification data, wherein the potential security vulnerabilities include the actual security vulnerability;
accessing a first database storing organizational data associated with the potential security vulnerabilities, via the communication device using the communication connections;
determining current ownership for the actual security vulnerability, based on the organizational data; and
determining a priority level for the actual security vulnerability;
present a dashboard including graphical elements and text associated with the actual security vulnerability and at least one of: the classification data, the current ownership, and the priority level, via a display device communicatively coupled to the at least one processor; and
transmit a notification or ticket to the current ownership of the actual security vulnerability, based on the priority level, via the communication device using the communication connections.

13. The system of claim 12, wherein the system further comprises a display device communicatively coupled to the at least one processor; and
wherein the at least one processor is further configured to:
perform data modeling, based on at least one of: ownership data, user data, host data, vulnerability data, trending data, and security risk data;
create and dynamically update graphical elements and text associated with the data modeling; and
present an integrated graphical interface that includes the graphical elements and text associated with the data modeling, via the display device.

14. The system of claim 12, wherein the at least one processor is further configured to:
monitor a delay between transmitting the notification or ticket and an updated current time;
determine continued existence of the actual security vulnerability at the updated current time;
determine an updated current ownership for the actual security vulnerability at the updated current time; and
when the delay exceeds a predetermined threshold,
re-ticketing the actual security vulnerability by transmitting a second notification or ticket to the updated current ownership, via the communication device using the communication connections.

15. The system of claim 12, wherein the at least one processor is further configured to:
obtain ticketing data for the actual security vulnerability, wherein the ticketing data includes at least the current ownership and the priority level;
transmit an alert, via the communication device, to an analyst computing device to communicate with the current ownership of the actual security vulnerability;
in response to transmitting the alert,
receive updated ticketing data based on communications received from the current ownership, wherein the updated ticketing data includes at least one of: a date for completion, and a procedure for completion;
update the notification or ticket, based on the updated ticketing data; and
store the updated ticketing data as compliance data for auditing purposes, in at least the memory component.

16. The system of claim 12, wherein the at least one processor is further configured to:
dynamically update the current ownership for the actual security vulnerability, according to a timed interval schedule, wherein the schedule includes the timed interval schedule; and
transmit communications according to the timed interval schedule, via the communication device, based on updating the current ownership, wherein the communications include the notification or ticket.

17. The system of claim 12, wherein the at least one processor is further configured to:
dynamically update the current ownership for the actual security vulnerability, according to an event-triggered schedule, wherein the schedule includes the event-triggered schedule; and
transmit communications according to the event-triggered schedule, via the communication device, based on updating the current ownership, wherein the communications include the notification or ticket.

18. A non-transitory, computer-readable medium containing instructions thereon, which, when executed by a processor, perform a method comprising:
establishing communication connections to at least one external computing device over the network, by the processor communicatively coupled to a memory device, wherein the computing devices include the at least one external computing device; and
performing an automated data security process according to a schedule, wherein the automated data security process comprises:
performing a scan of the at least one external computing device using one or more third-party software applications, by the processor via the network;
identifying an actual security vulnerability for the at least one external computing device, based on the scan, by the processor;
determining current ownership for the actual security vulnerability, by the processor, based on organizational data associated with potential security vulnerabilities for the at least one external computing device; and
determining a priority level for the actual security vulnerability, by the processor;
presenting a dashboard including graphical elements and text associated with the actual security vulnerability and at least one of: the classification data, the current ownership, and the priority level, via a display device communicatively coupled to the processor; and
transmitting a notification or ticket to the current ownership of the actual security vulnerability, based on the priority level, by the processor via the communication connections.

19. The non-transitory, computer-readable medium of claim 18, wherein the method further comprises:
obtaining classification data for potential security vulnerabilities applicable to the at least one external computing device; and
identifying the actual security vulnerability based on the scan and the classification data, by the processor, wherein the potential security vulnerabilities include the actual security vulnerability.

20. The non-transitory, computer-readable medium of claim 19, wherein obtaining the classification data further comprises obtaining keyword data associated with the potential security vulnerabilities; and
wherein the method further comprises:
using an Application Programming Interface (API) to initiate the scan via the one or more third-party software applications, by the processor, wherein the scan accesses vulnerability data for the at least one external computing device;
obtaining the vulnerability data from the one or more third-party software applications, by the processor via the API, wherein the vulnerability data includes the actual security vulnerability;
performing comparisons of the keyword data to the vulnerability data, by the processor via the API; and
identifying the actual security vulnerability, based on the comparisons.
